(19) United States
(12) Patent Application Publication
(10) Pub. No.: US 2002/0106120 A1
(43) Pub. Date: Aug. 8, 2002

(54) Method of analyzing in real time the correspondence of image characteristics in corresponding video images

(76) Inventors: Nicole Brandenburg, Berlin (DE); Michael Karl, Berlin (DE); Peter Kauff, Berlin (DE); Oliver Schreer, Berlin (DE)

Correspondence Address: Law Offices of Karl Hormann, 86 Sparks Street, Cambridge, MA, 02138-2216, US

(21) Appl. No.: 10/066,045

(22) Filed: Jan. 31, 2002

(30) Foreign Application Priority Data
Jan. 31, 2001 (DE) 101 05 423.8

(51) Int. Cl. G06K 9/00

(52) U.S. Cl. 382/154

(57) ABSTRACT

A hybrid method using both block recursion and pixel recursion of analyzing in real time the disparity of image characteristics in a pair of two-dimensional stereoscopic images to yield an improved three-dimensional appearance thereof. A scene is recorded by a stereoscopic camera system and its video images are subjected to a disparity analysis. For every pixel, the analysis detects the displacement between individual image characteristics and allows calculation of the motion parallax as it appears to a viewer. The is suitable for implementation with stereoscopic images of any kind and provides for basing the input image data for the block recursion on the left and on the right video image of a stereoscopic image pair and that the parameters of the stereo geometry are inclided in the pixel recursion for satisfying the epipolar condition. The method in accordance with the invention is used without additional aids with motion parallax in any spatial presentations.

### BACKGROUND OF THE INVENTION.

1. Field of the Invention

The invention, in general, relates to a method of analyzing in real time the correspondence of image characteristics in corresponding video images, which, for defining a correspondence vector field, proceeds from the digital input image data, having regard to selected optimizing criteria, and is based a hybrid recursion method which for detecting a corrected block vector includes, as a correspondence vector of a given actual pixel, a block recursion with an integrated pixel recursion for the correction of the block vector. More particularly, the invention relates to a method of improving the stereoscopic appearance of two-dimensional video images.

2. The Prior Art

A method of analyzing correspondence is used for carrying out observations of similarities between image characteristics in corresponding video images. The results thus obtained may be utilized for format conversion and for data compression. If the movement is selected as a correspondence between video images in a sequence of video images which over an interval of time correspond to each other, it is possible to make an estimate of the motion. Several methods have been developed for that purpose. Of the developed methods, a distinction can be drawn between two different approaches: the recursive block matching approach ( see [1]) and algorithms based upon optical flow (see [2]). The recursive block matching approach furnishes a non-dense motion vector field on the block basis by utilizing an appropriate power function as the optimizing criterion. {1} already explains the concept of utilizing but a few candidate vectors to avoid a search involving complex calculations in a defined area. By contrast, the optical flow approach makes use of the continuity between local gradients and between intensity differences in corresponding pixels in two video images, and it furnishes a dense motion vector field. Hierarchical concepts based on resolution pyramids are utilized, however, for reliably practicing this method in weakly structured areas. Such a pixel recursive concept results in significantly complex calculations which, for purposes of a real-time realization, poses a disadvantage.

The method in accordance with the invention is based upon the rapid hybrid recursion method in accordance with German Patent DE-A1 197 44 134. The method disclosed therein serves for estimating the motion between sequential video images, and its basic idea is efficiently to select a small group of relevant candidate vectors to minimize the calculation complexity for obtaining consistency in the motion vector field as a correspondence vector field. The known method is combining the advantages of the block recursive matching with the pixel recursive optical flow method and thus leads to a very precise motion estimation at a relatively low calculation complexity. For each actual block an optimized block vector is generated as a motion vector in several sections. Initially, a block vector is selected by block recursion in accordance with the predetermined optimizing criterion of the displaced block difference (DBD) from several candidate vectors. Thereafter, the block vector is actualized by pixel recursion in accordance with the optimizing criterion of the displaced pixel difference (DPD). Finally, a decision is made between the two block vectors in accordance with the predetermined optimizing criterion. The known method constitutes a merger of two distinct recursion methods of different approaches and advantages, yielding the term “hybrid recursion method”. It is limited to measures which may simply and clearly be applied to a few candidate vectors by utilizing as input values qualified results already present at their initial selection and wherein the generated intermediate results are subject to being examined in accordance with the optimizing criteria. Since the known method serves to estimate motion, chronologically sequential video images are used as input image data. In the method of DE-A1 197 44 134 video half images of three immediately sequential instants in time are utilized which are recorded by a single camera.

In order to generate realistic three dimensional video objects, e.g. of conference participants in a virtual video conference of high tell-presence, it is necessary to record them with a multiple camera system. Such future video conference applications it will be necessary to display individual participants in correct perspective in order to generate the important motion parallax for the viewer. If he moves his head, he has to be able, in a realistic presentation, to perceive different views of his conference participants. For this purpose, the movements of the head of the observer are detected by way of appropriate head tracking systems. The required three-dimensional representation of the spatial video objects becomes possible if correspondence is discovered between image characteristics of two video images of a stereoscopic pair of images recorded simultaneously by two cameras of a multiple camera system. The corresponding analysis will be called disparity analysis and furnishes, analogously to the motion estimate between chronologically sequential video images, the disparity vector as the correspondence vector which describes the spatial displacement of image characteristics in stereoscopic images. The correspondence vector field is thus generated by a disparity vector field. The virtual views may then, based on the detected disparity vector fields, be generated by actual or true image rendering techniques. The disparity analysis detects, for each pixel of a video image of a stereoscopic image pair, the displacement relative to the other video image. The value of the displacement then corresponds, in inverse proportion, to the depth of the corresponding 3D point in space. Several proposals of disparity analyses have already been put forward In connection with stereo applications. They represent consistent improvements of the proposals disclosed by publications {1} and [2].

Thus, one publication (see [3]) discloses a stereo real time system based upon the block matching proposal which calculates, on signal processors calculating in parallel, a correspondence search on a plurality of resolution pyramids. By comparison of the results the reliability of the disparity estimate may be improved significantly. At the same time, progression of errors may be avoided which occurs as an error source in a strictly hierarchic proposal. Another publication (see [4]) discloses the concept of candidate vectors utilizing a two-step block matching recursion. These described real time methods are based upon a pure block matching proposal and thus do not disclose the significant advantages of the hybrid recursion method of motion estimation described supra. Moreover, they were optimized for a simplified stereo geometry of the camera system, i.e. a structure parallel to the axis or slightly converging. However, because of the size of the display and the proximity to the display of the object to be recorded such camera configurations cannot be used in immersive video conference systems. In such applications the stereo cameras have to be aligned strongly convergent in order to capture the entire scene. Furthermore, for use in a real time system a particularly rapid definition of the disparity vector fields is required as is known from the described hybrid recursion method for motion estimation.

### OBJECT OF THE INVENTION

Proceeding from the hybrid recursion method of correspondence between image characteristics in corresponding video images as described in DE A1 197 44 134 in connection with the motion vector field as correspondence vector field for moving image characteristics in chronologically successive video images and having regard to the possibilities of the known methods of disparity analysis between two video images of a pair of stereo images, it is an object of the invention so to modify the basic hybrid recursion method as to render it suitable as a disparity analysis method for three-dimensionally displaying spatial video objects in any desired video views. Furthermore, it is to operate reliably and rapidly in any stereo geometries of the camera system used.

### BRIEF SUMMARY OF THE INVENTION

In accordance with the invention, the task is accomplished by a method which is an improvement of the known hybrid recursion method structured such that for detecting a disparity vector field as the correspondence vector field the input data are generated on the basis of the two video images of a pair of stereo images provided by a multiple camera system of any desired stereo geometry, the image characteristics in the two video images of the pair of stereo images corresponding to each other by way of a spatial displacement dependent upon the depth in space of the associated image characteristic and that, in order to satisfy the epipolar condition for clamping the corrected block vector to the appropriate epipolar line of the stereo geography, the parameters of the stereo geometry are included in the block vector correction.

The method in accordance with the invention is implemented to calculate the similarity between image characteristics of two video images which are recorded by two cameras of a stereo system oriented relative to each other in any desired manner. The vector which is representative of the displacement of the image characteristic in one of the video images relative to the position of the most similar image characteristic in the other video image is defined as the disparity vector. The method in accordance with the invention makes it possible quickly to define disparity vector fields for any desirable stereo geometries of the camera systems used. The video object recorded therewith may be described three-dimensionally. The detected virtual views may then, based upon the disparity vectors, be generated by true image rendering techniques. In this manner, a particularly realistic representation of the dimensionality of the recorded video object is made possible by generation of motion parallax at the viewer's. Without auxiliary viewing aids and without resorting to special displays, the viewer thus obtains a particularly realistic impression of the video object in real time. This makes possible a total integration of the participants into ever more significant video conferences which renders wholly insignificant those image forming techniques which are sometimes considered to be disturbing. Also, no disturbances arise as a result of time-lag processing, since the method operates mathematically in real time at 40 ms per frame at a sufficient precision of the disparity vector fields. It may thus also be used in connection with actual digital video standards, e.g. progressive CCIR601. To improve the reliability of the disparity analysis a consistency test between the two disparity vector fields (from left to right and from right to left) useful and especially effective. In an optimum case the sum of the two disparity vectors between corresponding image points has to be zero.

The method in accordance with the invention is based upon the concept of utilizing spatially neighboring candidate vectors as input for the block recursive disparity estimation. This is based upon the assumption that it is extremely likely that one of these candidate vectors represents an excellent approximation of the disparity at the actual pixel position. In addition to a significant reduction in the calculation time, this method leads to spatially consistent disparity vector fields. However, since in the disparity sequences chronological discontinuities may also occur which, at a synthesis based on the disparity analysis, result in visible and thus extremely disturbing artefacts, a chronological candidate from the disparity analysis of the preceding stereo image pair is used in addition. As a modification of the known hybrid recursive method with a block recursive component containing the pixel recursive component for an after-correction of the searched for disparity vector, the method in accordance with the invention displays substantial differences and developments relative to known hybrid recursive method. The right and left video images of a stereoscopic pair of images recorded by a stereoscopic camera now form the basis for the input image data. Thus corresponding images from an identical instant in time are present at the input. The correspondence between the video images in the method in accordance with the invention results from an image of a 3D spatial point at different positions in the image plane of two cameras of different image angularities of a stereoscopic camera. In this connection, providing a plurality of stereoscopic cameras in a multiple camera system leads to an expansion of the motion parallax. The spatial displacement between corresponding image characteristics thus is a measure of the depth of the corresponding 3D point of the analyzed object. For this reason, the disparity vector which may be detected by the method in accordance with the invention corresponds to the spatial displacement of the then actual block. Moreover, an expansion resulting from the stereo geometry of the camera is introduced into the pixel recursive component. Since in general the pixel recursion provides no vectors corresponding to the stereo geometry, the detected disparity vectors are transferred to (so-called clamping) corresponding vectors along the epipolar line of the respective stereo geometry.

In the block recursion a value corresponding to the suitably selected optimizing criterion is defined for each of three candidate vectors. In accordance with the optimizing value the best candidate vector is selected for the actual pixel and is transferred to the pixel recursion. Utilizing the optical flow equation, a pixel recursive process is performed at different positions in the actual block within the environment of the actual pixel for defining actualized candidate vectors. In this connection, by calculating the spatial and chronological gradient, an update vector is defined which usually has a horizontal and a vertical component which initially results in an actualized block vector from the input phase and, during the subsequent pixel recursion, n an actualized disparity vector from the preceding recursion step. During these various pixel recursive processes, an offset vector is detected in each recursive step and results in a new update vector. The decision as to the optimum update vector is based on the displaced pixel difference (DPD), and the update vector is selected with the smallest difference. Since this update vector does not necessarily satisfy the epipolar condition of the stereo geometry, clamping is performed at this position. To this end, utilizing the parameters of the stereo geometry, the disparity vector is defined which satisfies the epipolar condition and is positioned most closely to the selected update vector. This means that for a pixel which is an image of a point in space, the corresponding pixel in the other video image must be positioned on the epipolar line of the stereo geometry and vice versa. The corrected disparity vector is then returned to the block recursive component. There, the corrected candidate vector from the pixel recursion is finally compared against the best candidate vectors from the input phase of the block recursion, the selected optimizing criterion being again employed here. Thus the best candidate vector is the block vector of the actual block position and is stored for the next block recursion.

Input image data based upon the two images of a stereoscopic camera system are submitted to the method in accordance with the invention. It is possible to provide for a direct connection, which is to say that recorded stereo images are digitized directly. In accordance with a further aspect of the method in accordance with the invention it is also possible to generate the input image data as transformed equivalents from the two video images of a stereoscopic pair of images. In accordance with a further embodiment, the two transformed equivalents may be generated by rectification of the individual video images. In the rectification axially parallel views are generated from convergent video images by application of a two-dimensional transformation. However, the two stereoscopic images may also be subjected to any other transformation suitable to the defined task. Furthermore, the transformed input image data derived from a pair of stereoscopic images need not be identical for the block recursion and the pixel recursion. In the case of separate data flows differently transformed equivalents of a pair of stereoscopic images may be processed as input image data in the block recursion and in the pixel recursion. The parameters of the given stereo geometry are thus fed to the pixel recursion by way of an additional input. Where transformed equivalents are used as input image signals the optimizing criterion must be selected accordingly in the block recursion. In accordance with a further embodiment of the method in accordance with the invention it is advantageous to select the displaced block difference (DBD) as the optimizing criterion in the block recursion and to select the displaced pixel difference (DPD) as the optimizing criterion in the pixel recursion.

In the block and pixel recursion of the method in accordance with the invention, the candidate vectors in the two-dimensional image plane in the case of a given stereo geometry of the camera system are also two-dimensional vectors. As has already been explained, corresponding characteristics in two video images must be positioned on the epipolar line determined by the given stereo geometry in order to satisfy the epipolar condition. Thus, the search for a suitable candidate vector is in principle limited to a one-dimensional search space. This fact may be made use of by a suitable parametrization of the epipolar line. In accordance with a further embodiment of the invention it is thus advantageous to limit the detection of the disparity vector of an actual pixel at a given time to a one-dimensional search space by parametrization of the epipolar line of the stereo geometry. Such parametrization is already known, albeit in connection with a complex power function for disparity estimation (see [5]). However, use of this parametrization in a hybrid block and pixel recursion disparity analyzing method are not known. In the context of the method in accordance with the invention this parametrization means that in the block as well as in the pixel recursive component the candidate vectors may only be described by one component λ. Hence, the search for the optimum candidate vector in the pixel recursive component occurs solely along the parameter λ. An inverse calculation is thus necessary for calculating the optimizing value and of the displaced pixel difference (DPD) to derive the corresponding two-dimensional coordinates from the λ parameter. This is done within the calculation module and corresponds to a coordinate transformation.

In accordance with a further embodiment of the invention, a further reduction of the area to be analyzed in the video images and, hence, a significant acceleration of the calculation process results from limiting the disparity analysis to the limited number of pixels of a closed video object. In the mentioned video conference scenario in particular, the disparity analysis may be limited to the conference participant and, more particularly, his head and torso, since only he will be transmitted while the virtual scene is inserted.

In order to prevent spatially dependent results it is useful, in accordance with a further embodiment of the invention, to process individual blocks in the block recursion method independently of a direction. More particularly, this may be done in a treble alternating way such that initially the blocks are processed for all even or all uneven display lines and by alternating the processing direction in sequential display lines and, in successive stereo image pairs, by alternatingly starting the block recursion in the uppermost and lowest display line. This multiple meander system results in processing the block positions substantially independently of a direction, since by cumulation of all measures to a treble meander all positions around the actual pixel will have been selected as pixel candidates after no less than two images. In accordance with a further embodiment of the invention, the operating efficiency may be improved by carrying out strictly horizontal or strictly vertical processing.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 is a block diagram of the method in accordance with the invention;

FIG. 2 is a presentation of the epipolar geometry; and

FIG. 3 is a multiple meander for processing individual pixels independently of any direction.

### DETAILED DESCRIPTION OF THE PREFERRED EMBODIMENTS

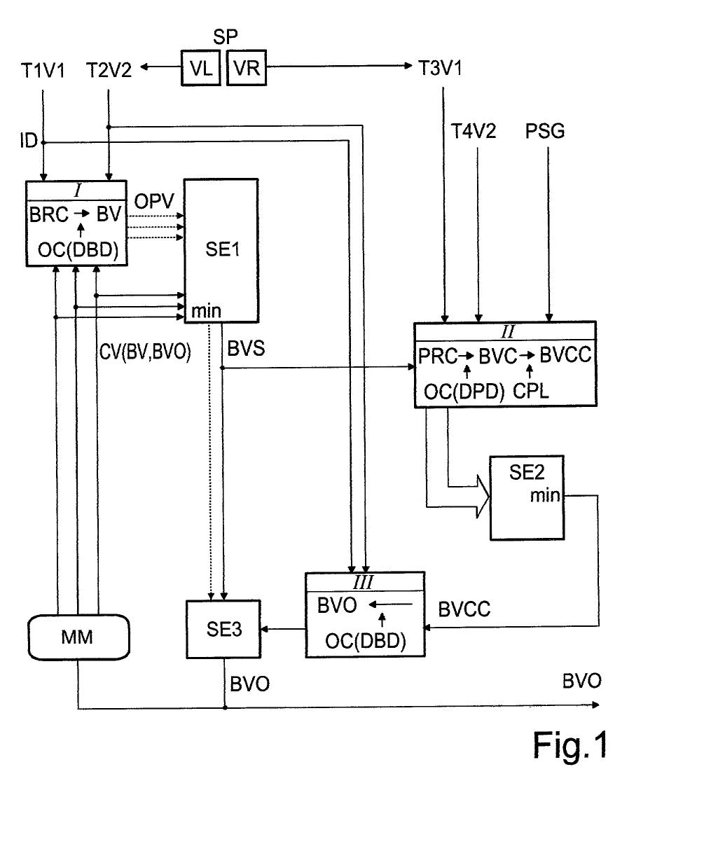

FIG. 1 depicts the general design of the method in accordance with the invention which serves to detect a field of optimized block vectors BVO as a measure of occurring disparity. The method in accordance with the invention may be practiced strictly mathematically without any additional hardware components. It may be practiced, for instance, with a commercially available high quality Pentium III processor of 800 MHZ. The method may be divided into three sections:

in a first section I the candidate vectors CV are evaluated from prior recursion steps for actual block position by recursive block matching. Transformed video image data TIV1, T2V2 of the left and right video image V1, V2 of a stereoscopic image pair SP are utilized as input image data ID. Following initializing with default values, the requisite three candidate vectors CV are made available from a memory MM. Calculation of the minimum numerical value OPV takes place in the block recursion BRC after setting the transformation of the video image data TV1, TV2 with a suitable optimizing criterion OC. In the process sequence shown, this is the displaced block difference DBD. The candidate vector CV associated with the minimum numerical value OPV is selected in a selection unit SE1 and is transferred to the next section as a block starting vector BVS.

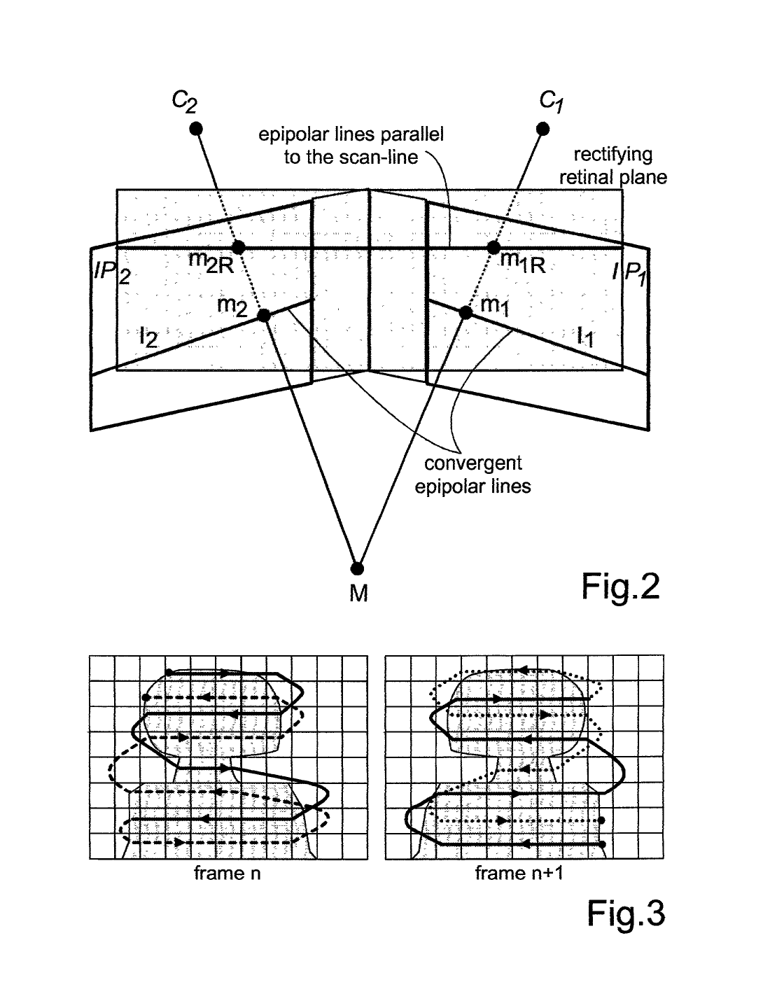

In the next section 11 a pixel discursion PRC is performed commencing with the block start vector BVS. Proceeding from the actual stereo image pair SP, transformed video image data T3V1, T4V2 are transferred to the pixel discursion PRC. In addition, the parameters of the corresponding stereo geometry PSG are entered into the pixel recursion PRC. Calculation of the corrected block vector BVC takes place on the basis of a simplified calculation of the optical flow made up of the local gradient and the gradient between the stereo images. The displaced pixel difference (DPD) is utilized as optimizing criterion OC when evaluating the corrected block vector BVC. Since the block vector BVC thus calculated does not usually satisfy the epipolar condition, clamping to the epipolar line CPL is subsequently carried out to find the block vector BVCC positioned closest to the corrected block vector BVC and satisfying the epipolar condition. See also FIG. 2. The pixel recursion results in a plurality of doubly corrected block vectors BVCC, the best corrected block vector BVCC being then selected in a further selection unit SE2 on the basis of the minimum displaced pixel difference DPD and transferred to a third section III.

Applying the suitable optimizing criterion, the optimizing value for the corrected and clamped block vector BVCC is calculated. The optimized block vector BVO is finally selected in a third selection unit SE3 on the basis of the result of section III and the selection unit SE1 from the block start vector BVS and the corrected block vector BVCC and is transferred to the memory MM as well as issued for establishing the disparity vector field. The process then commences anew with the next actual pixel or with the next stereo image in case all pixels in the object range have been processed.

In FIG. 2, there is shown an epipolar geometry the parameters of which are entered in the pixel recursion PRK by satisfying the epipolar condition. Proceeding from a spatial point M and its two projection points m₁, nd m₂ in the two image planes I₁ and I₂ of a stereo device, the epipolar geometry says that an optical beam penetrating points m₁ and M is imaged on a corresponding epipolar line I₂ in image plane IP₂. Therefore, point m₂ has to lie on epipolar line I₂, provided it is not covered in the second view. Inversely, point m₁ would be positioned on the complementary epipolar line I₁. This basic relationship has been given expression in the known epipolar equation [1] in which F is the fundamental matrix (see [6]). The fundamental matrix contains the camera parameters of each camera of the stereo system as well as the geometric relationship between both cameras. The tilde over the projection points m₁, m₂ denotes that their surface coordinates (x, y) have been expanded into the space (x, y, 1). It is thus possible, to use the two-dimensional vectors of the image plane in the projected three-dimensional space.

m₁^{T}Fm₂=0 [I]

For this reason adjustment of the corresponding projection points m₁, m₂ may always be reduced to a one-dimensional search along epipolar lines I₁, I₂ which for each of the two views is calculated as follows:

I₁=Fm₂ and I₂=F^{T}m₁ [II]

Assuming a conventional stereoscopic camera structure with cameras aligned in a strongly convergent manner, the one-dimensional search may be implemented in two different ways (see [7]). The first possibility is a single step solution in which the one-dimensional search is carried out directly along an epipolar line arbitrarily oriented because of the strongly convergent camera alignment. The second possibility is a dual step method which initially provides for a virtual rotation of both cameras until a parallel stereo geometry has been reached. This pre-process step is called “rectification” and in general produces trapezoidally distorted images with horizontal epipolar lines. The corresponding points m_{1R}, m_{2R} in the rectified images may now be searched along horizontal epipolar lines I_{R}. While in this way the one-dimensional search may be simplified further, the rectification process requires additional calculation time. The rectification requires the derivation of two transformation matrices T1 and T2 from the camera geometry, as has also been described in the prior art (see [8]). The resulting matrices may then be used for the transformation of each pixel of the original images to a rectified view [III]:

m_{1T}−T₁·m₁ and m_{2T}=T₂·m₂ [III]

FIG. 3 is a simplified rendition of meanderingly scanning of individual video images for processing individual pixels independently of direction. The scanning relates only to a video object of arbitrary contour; this resulted in a shortened calculation time. At the left side, the only the even-numbered image frames are scanned, on the right side the uneven-numbered frames are scanned. The first run of the even-numbered image frames is shown in solid lines, commences at the top and includes the uneven display lines only. The second run is shown in dashed lines, covers the processing of the even-numbered display lines and approaches the first run from a lower starting point. In the following video image pair the runs and starting points are exactly reversed. By this three-fold meander, complete independence of the pixel processing direction and, hence, the best possible results of the disparity analysis for evaluating the depth ratios can be obtained.

The basic concept and individual preferred embodiments of the present invention is the subject of a publication by Kauff, P.; Brandenburg, N.; Karl, M.; Schreer, O.: “Fast Hybrid Block and Pixel-Recursive Disparity Analysis or Real-Time Applications in Immersive Tell-Conference Scenarios”; 9^{th} International Conference in Central Europe on Computer Graphics, Visualization and Computer Vision 2001, in cooperation with EUROGRAPHICS and IFIP WG 5. 10. WSCG′2001: Conference Proceedings, Editor(s): Skala, V., Pilsen, Czech Republic; Univ. West Bohemia, pp. 198-205, Vil. 1, Pilsen, Czech Republic, 5-Feb. 9, 2001.

Publications Referred to in the Specification

[1] G. De Haan et al.: “True-Motion Estimation with 3D Recursive Block Matching”, IEEE Trans on Circuits, Systems and Video Technology 3, pp. 368-379,1993.

[2] J. L. Barron, D. J. Fleet and S. S. Beauchemin: “Performance and Optical Flow Techniques”, Int. Journal on Computer Vision, Vol.12, No.1, 1994.

[3] O. D. Faugeras et al.: “Real-Time Correlation-Based Stereo: Algorithm, Implementations and Applications”, INRIA Research Report No. 2013, INRIA Sophia-Antipolis, August 1993.

[4] J.-R. Ohm et al.: “A Real-Time Hardware System for Stereoscopic Videoconferencing with Viewpoint Adaptation”, Image Communication, Special Issue on 3D-TV, January 1998.

[5] L. Alvarez, R. Deriche, J. Sanchez and J. Weickert: “Dense Disparity Map Estimation Respecting Image Discontinuities: A PDE and Scale-Space Based Approach”, INRIA Research Report No. 3874, INRIA, Sophia-Antipolis, January 2000.

[6] Z. Zang, G. Xu: “Epipolar Geometry in Stereo, Motion and Object Recognition”, Kluwer Academic Publisher, Netherlands, 1996.

[7] O. Schreer, N. Brandenburg, P. Kauff: “Disparitatsanalyse konvergenter und rektifizierter Stereoansichten: Eine vergleichende Untersuchung” Mustererkennung 200, 22. DAGM-Symposium, Kile, Sep. 13-15 2000, Springer-Verlag, pp. 59-66.

[8] E. Fusiello, E. Trucco, A. Verri: “Rectification with Unconstrained Stereo Geometry”, British Machine Vision Conference 1997, Essex, pp. 400-409, September 1997.

What is claimed is:

1. A method of analyzing in real time the correspondence of image characteristics in corresponding video images which, taking into consideration selected optimizing criteria, proceeds from the digital input image data for defining a correspondence vector field and which is based on the hybrid recursion method which includes a block recursion with an integrated pixel recursion for detecting a corrected block vector as the correspondence vector of the given actual pixel, characterized by the fact that for detecting a disparity vector field as correspondence vector field the input image data are generated on the basis of the two video images of a stereoscopic image pair generated by a multiple camera system of arbitrary stereo geometry, whereby the image characteristics in the two video images of the stereoscopic image pair correspond to each other by way of a spacial displacement dependent upon the depth of the associated image characteristic in space, and that for satisfying the epipolar condition for clamping the corrected block vector to the given epipolar line of the stereo geometry, the parameters of the stereo geometry are included in the correction of the block vector.

2. The method according to claim 1, characterized by the fact that the input image data are generated as transformed equivalents from the two video images of a stereoscopic image pair.

3. The method according to claim 2, characterized by the fact that the transformed equivalents are generated by rectification of the stereoscopic image pair.

4. The method according to claim 3, characterized by the fact that differently transformed equivalents of a stereoscopic image pair are processed as input image data in the block recursion and in the integrated pixel recursion.

5. The method according to claim 4, characterized by the fact that the optimizing criterion selected in the block recursion is the displaced block difference and the optimizing criterion selected in the pixel recursion (PRC) is the displaced pixel difference.

6. The method according to claim 5, characterized by the fact that detection of the disparity vector of the given actual pixel is limited to a one-dimensional search space by parametrization of the epipolar lines of the stereo geometry.

7. The method according to claim 6, characterized by the fact that that the disparity analysis is restricted to the limited number of pixels of a closed video object.

8. The method according to claim 7, characterized by the fact that that the in the block recursion the individual blocks are processed independently of direction.

9. The method according to claim 8, characterized by the fact that that initially the blocks are processed for all even-numbered or uneven-numbered display lines and that in consecutive display lines the processing direction changes and that in consecutive stereoscopic image pairs the block recursions alternatingly starts in the uppermost and lowest display line.

10. The method according to claim 9, characterized by the fact that processing is implemented strictly horizontally or strictly vertically.
